(19) United States
(12) Patent Application Publication
(10) Pub. No.: US 2015/0259468 A1
(43) Pub. Date: Sep. 17, 2015

(54) HIGH IMPACT STRENGTH POLYMERS

(71) Applicant: TEXAS STATE UNIVERSITY-SAN MARCOS, San Marcos,, TX (US)

(72) Inventors: Gary W. Beall, San Marcos, TX (US); Yelena Nash, San Marcos, TX (US)

(21) Appl. No.: 14/434,278

(22) PCT Filed: Oct. 9, 2013
(86) PCT No.: PCT/US2013/064019

§ 371 Date: Apr. 8, 2015

Related U.S. Application Data
(60) Provisional application No. 61/795,020, filed on Oct. 9, 2012.
(60) Provisional application No. 61/795,021, filed on Oct. 9, 2012.

(51) Int. Cl. C08G 63/199

(52) U.S. Cl. CPC C08G 63/199

(57) ABSTRACT

In an embodiment, a copolymer is formed from a monomer composition that includes a 2,2,4,4-tetraalkyl-1,3-cyclobutanediol monomer; one or more aromatic dicarboxylic acids, aromatic dicarboxylic diesters, and/or aromatic dicarboxylic anhydride; 1,3-propanediol or 1,4-butanediol; and 2,2-dimethyl-1,3-propanediol. In some embodiments, a copolymer is formed from a monomer composition that includes a 2,2,4,4-tetraalkyl-1,3-cyclobutanediol monomer, wherein at least 90% of the 2,2,4,4-tetraalkyl-1,3-cyclobutanediol monomer is in the cis- or trans-form.

### BACKGROUND OF THE INVENTION

1. Field of the Invention

The invention generally relates to high impact strength polymers. More particularly the invention relates to copolymers formed from diols and carboxylic acids.

2. Description of the Relevant Art

In recent years there has been a question raised about bisphenol A (BPA) containing polymers and the potential health risk from products made using BPA. BPA is utilized in many epoxies, urethanes and polycarbonates. Polycarbonates containing BPA, in particular, have been one of the best polymers for high impact applications including ballistics protection in transparent armor. A potential replacement for BPA polycarbonates is based upon 2,2,4,4 tetraalkyl-1,3-cyclobutanediol (TACB) monomers. Copolymers of dicarboxylic acids, diols and TACB are characterized as high durability and high impact resistance materials.

Current formulations that use TACB monomers suffer from having a low (less than 100° C.) glass transition temperature (Tg). The relatively low Tg of current formulations leads to accelerated aging of the material, which can cause the material to become brittle and discolored. This can be especially problematic in warmer climates where higher environmental temperature can lead to accelerated aging of low Tg polymers.

### SUMMARY OF THE INVENTION

In one embodiment, a polymer is formed by reaction of a monomer composition, wherein the monomer composition comprises: a 2,2,4,4-tetraalkyl-1,3-cyclobutanediol monomer; one or more aromatic dicarboxylic acids, aromatic dicarboxylic diesters, and/or aromatic dicarboxylic anhydride; 1,3-propanediol or 1,4-butanediol; 2,2-dimethyl-1,3-propanediol; and a catalyst that promotes condensation of an alcohol with a carboxylic acid and/or a carboxylic acid ester and/or a carboxylic acid anhydride.

In another embodiment, a polymer is formed by reaction of a monomer composition, wherein the monomer composition comprises: a 2,2,4,4-tetraalkyl-1,3-cyclobutanediol monomer, wherein at least 90% of the 2,2,4,4-tetraalkyl-1,3-cyclobutanediol monomer is in the cis form; one or more aromatic dicarboxylic acids, aromatic dicarboxylic diesters, and/or aromatic dicarboxylic anhydride; 1,3-propanediol or 1,4-butanediol; and a catalyst that promotes condensation of an alcohol with a carboxylic acid and/or a carboxylic acid ester and/or a carboxylic acid anhydride.

In another embodiment, a polymer which is formed by reaction of a monomer composition, wherein the monomer composition comprises: a 2,2,4,4-tetraalkyl-1,3-cyclobutanediol monomer, wherein at least 90% of the 2,2,4,4-tetraalkyl-1,3-cyclobutanediol monomer is in the trans form; one or more aromatic dicarboxylic acids, aromatic dicarboxylic diesters, and/or aromatic dicarboxylic anhydride; 1,3-propanediol or 1,4-butanediol; and a catalyst that promotes condensation of an alcohol with a carboxylic acid and/or a carboxylic acid ester and/or a carboxylic acid anhydride.

A method of forming a polymer includes: forming a monomer composition comprising: a 2,2,4,4-tetraalkyl-1,3-cyclobutanediol monomer; one or more aromatic dicarboxylic acids, aromatic dicarboxylic diesters, and/or aromatic dicarboxylic anhydride; 1,3-propanediol or 1,4-butanediol; and a catalyst that promotes condensation of an alcohol with a carboxylic acid and/or a carboxylic acid ester and/or a carboxylic acid anhydride; heating the monomer composition to a temperature greater than about 200° C. at a pressure of less than 760 mm Hg but greater than 1 mm Hg; cooling the heated monomer composition; and heating the cooled monomer composition to a temperature greater than about 200° C. at a pressure of less than 1 mm Hg to form the polymer.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

In one embodiment, an improved high impact strength copolymer may be formed by polycondensation of a monomer composition that includes: a 2,2,4,4-tetraalkyl-1,3-cyclobutanediol (TACB) monomer; one or more aromatic dicarboxylic acids or esters thereof; 1,3-propanediol or 1,4-butanediol; and 2,2-dimethyl-1,3-propanediol. The resulting copolymer exhibits the same high impact strength, shape memory, and self-healing properties seen in other polymers made using TACB monomers, but has a Tg greater than 100° C., which inhibits embrittlement of the resulting copolymer due to aging.

TACB monomers have the general structure (I):

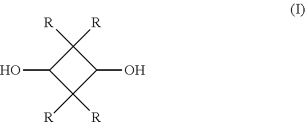

where each R is an alkyl group. In one embodiment, each R is independently a C₁-C₈ branched or unbranched alkyl group. Specific examples of TACB monomers include monomers in which each R is the same alkyl group. For example, each R may be methyl (i.e., 2,2,4,4-tetramethyl-1,3-cyclobutanediol, TMCB) or ethyl (i.e., 2,2,4,4-tetraethyl-1,3-cyclobutanediol, TECB). TACB monomers can exist in two isomeric forms, cis- and trans-. Projection views of cis- and trans-TACB monomers are shown below.

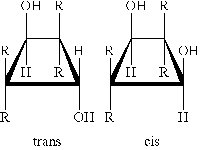

As shown, the trans-isomer has the hydroxyl groups oriented on opposing sides of the cyclobutane ring, while the cis-isomer has the hydroxyl groups oriented on the same side of the cyclobutane ring.

Commercially available TACB monomers are typically mixtures of cis/trans isomers having a cis/trans ratio ranging between 33:67 to 67:33 (e.g., 43/57). In some embodiments, it is desirable to use TACB monomers having a purity of one isomer (either cis- or trans-) of greater than 90%; greater than 95%; or greater than 99%. Separation of cis- and trans-TACB isomers may be carried out by stepwise recrystallization from ethyl acetate according to the process described by Shirrel et al. “The Crystal and Molecular Structure of cis-2,2,4,4-Tetramethyl-1,3-cyclobutanediol” Acta Cryst. (1976) B32, 1867, which is incorporated herein by reference.

Dicarboxylic acids include C₈-C₂₀ aromatic dicarboxylic acids. Exemplary dicarboxylic acids include, but are not limited to, terephthalic acid, isophthalic acid, phthalic acid, and 2-6-napthalene dicarboxylic acid. Diesters of aromatic dicarboxylic acids may also be used and include dimethyl, diethyl, and diisopropyl diesters. In some embodiments, anhydrides of the dicarboxylic acids may be used (e.g., if the two carboxylic acid groups are in an ortho-orientation). In some embodiments, terephthalic acid dimethyl ester is used as a monomer to form the copolymer.

The monomer composition includes the following percentages of the components: between about 15 mole percent and about 25 mole percent of TACB monomer; between about 10 mole percent and about 20 mole percent of 1,3-propanediol or 1,4-butanediol; between about 10 mole percent and about 20 mole percent of 2,2-dimethyl-1,3-propanediol; and between about 40 mole percent and about 60 mole percent of one or more aromatic dicarboxylic acids or esters.

The polymers are prepared by condensation polymerization of a monomer composition that includes: TACB monomer; one or more aromatic dicarboxylic acids or esters; 1,3-propanediol or 1,4-butanediol; and 2,2-dimethyl-1,3-propanediol. In an embodiment, polymerization is carried out in the presence of a catalyst that promotes condensation of an alcohol with a carboxylic acid and/or a carboxylic acid ester and/or a carboxylic acid anhydride. Suitable catalysts for the polycondensation of the monomer composition include catalysts that include titanium, manganese, cobalt, zinc, antimony, tin, lead or germanium. Exemplary tin catalysts include but are not limited to dibutyltin oxide, tin acetate, tin oxalate, dibutyltin dimethoxide, tin isopropoxide, tributyltin acetate, dioctyltin oxide, dimethyltin dichloride, triphenyltin acetate, tin amyloxide, dibutyltin bis(2-ethylhexanoate), dibutyltin dilaurate, tin chloride, potassium tin oxide, tin oxide, and bis(tributyltin oxide). In an alternative method, inorganic acid catalysts (e.g., phosphoric acid) and organic acid catalysts (e.g., toluene sulfonic acid) may be used to catalyze the polycondensation of the monomer composition.

Polycondensation of the monomer composition can be carried out by heating the monomer composition having a catalyst at a temperature sufficient to distill off the alcohol derived from the ester (e.g., methanol, if a dimethyl ester is used), and then applying sufficient vacuum and heat to distill off the excess diols. In an embodiment, the first stage of the process (transesterification) may be performed at a temperature of between about 180° C. to about 250° C. The first stage may be performed at atmospheric pressure or under a vacuum. In one embodiment, the first stage vacuum is less than 760 mm Hg but greater than 1 mm Hg. The second stage of the reaction (vacuum distillation of alcohol/excess diols) may be performed at temperatures above about 250° C. For the second stage the vacuum is below about 1 mm Hg, or below about 0.5 mm Hg. The polycondensation may be carried out batchwise in a conventional reactor or continuously as in an extruder.

The polycondensation may be accomplished using a catalyst. In one embodiment, the TACB monomer and dicarboxylic acid diester may undergo transesterification with a tin catalyst, followed by addition of: 1,3-propanediol and/or 1,4-butanediol; and 2,2-dimethyl-1,3-propanediol and an optional catalyst (e.g., titanium butoxide). After addition of the diol components and catalyst the reaction is heated under vacuum.

In an alternate embodiment, the TACB monomer, dicarboxylic acid diester and diol components (1,3-propanediol and/or 1,4-butanediol; and 2,2-dimethyl-1,3-propanediol) may undergo transesterification in the presence of a tin catalyst by heating to a temperature of between about 180° C. to about 250° C., followed by heating under vacuum at a temperature greater than about 250° C. Additional catalyst may be added before the second stage is started.

In a specific example, a mixture of TACB monomer, dicarboxylic acid diester and a molar excess of the diol components (1,3-propanediol and/or 1,4-butanediol; and 2,2-dimethyl-1,3-propanediol) is heated to about 190-200° C. in the presence of a tin catalyst to initiate the transesterification reaction, exhibited by boiling of the mixture due to loss of alkyl alcohol (e.g., methanol). The first stage reaction is performed under a slight vacuum (less than 760 mm Hg but greater than 1 mm Hg). The mixture is monitored for a reduction in boiling and, when reduced boiling is observed, the temperature of the mixture is increased by 10° C. This process is repeated until a final temperature of between about 240° C. and 250° C. is reached. Once the final temperature is reached, heating is continued until boiling and/or the collection of alkyl alcohol stops. In the second stage the mixture is cooled to room temperature, additional tin catalyst is, optionally, added, and the mixture is heated under vacuum. During the second stage the mixture is heated by ramping the temperature up until boiling, holding the temperature for ten minutes, then increasing the temperature by 10° C., stepwise until 260° C. is reached. The reaction is stirred under vacuum (less than 1 mm Hg) at this temperature until a high molecular weight polymer formed. This can be determined by noting when the polymer climbs a stirring rod used to stir the mixture.

In an embodiment, an improved high impact strength copolymer may be formed by polycondensation of a monomer composition that includes: a TACB monomer with at least 90% of the monomer being in the trans-form; one or more aromatic dicarboxylic acids or esters thereof; and 1,3-propanediol or 1,4-butanediol. The monomer composition may, optionally, include 2,2-dimethyl-1,3-propanediol. In other embodiments, at least about 95% or at least about 99% of the TACB monomer is in the trans-form. Polycondensation is performed using any of the reaction procedures set forth above. It was found that polycondensation of the monomer composition having a trans-rich TACB monomer occurred faster than a cis/trans mixture of TACB monomers. For example, the second stage of the reaction was substantially complete in 2 hours for the trans rich material, as opposed to 3 hours for the 43/57 cis/trans monomer mixture. This difference in rate may be due to lower steric hindrance with the hydroxyl groups oriented on opposite sides of the cyclobutane ring.

In an embodiment, an improved high impact strength copolymer may be formed by polycondensation of a monomer composition that includes: a TACB monomer with at least 90% of the monomer being in the cis-form; one or more aromatic dicarboxylic acids or esters thereof; and 1,3-propanediol or 1,4-butanediol. The monomer composition may, optionally, include 2,2-dimethyl-1,3-propanediol. In other embodiments, at least about 95%, or at least about 99% of the TACB monomer is in the cis-form. Polycondensation is performed using any of the reaction procedures set forth above. It was found that polycondensation of the monomer composition having a cis-rich TACB monomer occurred slower than a cis/trans mixture of TACB monomers. For example, the second stage of the reaction was substantially complete in 3.5 hours for the cis-rich material, as opposed to 3 hours for the 43/57 cis/trans monomer mixture. This difference in rate may be due to higher steric hindrance with the hydroxyl groups oriented on opposite sides of the cyclobutane ring.

Copolymers formed using mixed or isomerically purified TACB monomers, dicarboxylic acid diesters, and a mixture of diols that, optionally includes 2,2-dimethyl-1,3-propanediol produce polymers that exhibit high impact strength (e.g., a notched Izod impact strength of greater than 500 J/m, or greater than 600 J/m, or greater than 700 J/m, or greater than 800 J/m). Additionally, it was found that such polymers exhibit shape memory properties. Shape memory properties are exhibited when a polymer that is deformed from its original shape regains its original shape when heated at or slightly above its Tg temperature. The copolymers described herein also exhibited self-healing properties. Self-healing properties are exhibited when a polymer that is damaged (e.g., by forming marks or dents in the polymer) regains an undamaged appearance when heated at or slightly above its Tg temperature.

It was, surprisingly, found that the use of 2,2-dimethyl-1,3-propanediol in the composition increase the Tg of the sample to above 100° C. For example, two polymeric compositions were compared. One was formed using a monomer composition that includes 1,3-propanediol, while the other was formed by using a mixture of 1,3-propanediol and 2,2-dimethyl-1,3-propanediol (the same amount of “diols” was used in each composition. The copolymer formed using 1,3-propanediol, in the absence of 2,2-dimethyl-1,3-propanediol, had a Tg of about 98° C., while the copolymer formed using a mixture of 1,3-propanediol and 2,2-dimethyl-1,3-propanediol had a Tg of about 108° C. This result was unexpected since the boiling point of 2,2-dimethyl-1,3-propanediol (208° C.) is less than the boiling point of 1,3-propanediol (210-212° C.).

Copolymers made using either cis-TACB or trans-TACB isomers give copolymers that have different properties. When utilizing the trans-form of a TACB monomer, the resulting copolymer is linear, crystalline and exhibits a higher density (1.8 g/cc) than copolymers made using a mixture of TACB isomers. The trans-polymer may also be spun into aligned, high tensile strength fibers, similar to Kevlar polymers. Copolymers formed using the cis form of a TACB monomerporduces a polymer that is amorphous and exhibits a higher modulus, a higher tensile strength, a higher Tg, and a higher impact resistance than copolymers having a similar composition, but formed with a mixture of TACB isomers.

### Examples

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Copolymer Synthesis Using 2,2-Dimethyl-1,3-Propanediol

### Monomer Composition

dimethyl terephthalate 0.6 mol*194.188 g/mol=116.51 g

2,2,4,4-tetramethyl-1,3-cyclobutanediol 0.3 mol*144.21 g/mol=43.264 g

1,3-propanediol 0.225 mol*76.9 g/mol=17.3 g

2,2-dimethyl-1,3-propanediol 0.225 mol*104.14 g/mol=23.43 g

dibutyltin oxide 0.65 g

The monomer composition was loaded into a reactor and the reactor was placed under a slight vacuum. Heating of the monomer composition was initiated. The heating rate was regulated by first heating the monomer composition quickly until distillation started. When distillate appeared (around 190° C.) the temperature was held until distillation rate, began to slow down. The temperature was gradually adjusted to maintain the same distillation rate by increasing the temperature by 10° C. and waiting until the distillation begins to slow down. Once the distillation rate slows the temperature of the monomer composition is again raised by 10° C. This continues until a temperature of about 240° C. is reached. No sublimation in the distillation tube appeared and very few or no solids appeared in the collection flask. About 48-51 mL of methanol was collected.

After cooling the mixture to room temperature, 0.65 g of dibutyltin oxide was added to the reaction mixture. The reaction was heated under vacuum (less than 1 mm Hg) with the heating rate regulated to maintain moderate boiling of the polymerizing system (normally 10° C. increments) after boiling begins until a final temperature of 260° C. is reached. When copolymer climbed up the stirring shaft, it was a viscous yellow substance. After the reaction was complete the mixture was pulsed with vacuum/Ar 3-4 times to avoid bubbles in polymer. The formed copolymer was then left under an Ar/N₂ atmosphere until has cooled to room temperature.

### Synthesis of Copolymers Using Pure Isomers of TACB Monomers

Separation of cis and trans isomers of TACB monomers was carried out by stepwise recrystallization from ethyl acetate as described by Shirrel et al. “The Crystal and Molecular Structure of cis-2,2,4,4-Tetramethyl-1,3-cyclobutanediol” Acta Cryst. (1976) B32, 1867, which is incorporated herein by reference. The synthesis of the co-polyterephthalate 2,2,4,4-tetramethyl-1,3-cyclobutanediol, using the monomers 1,3-propanediol and dimethylterephthalate was carried out using methods as described herein.

Terephthalate copolyesters with cis and trans 2,2,4,4-tetramethyl-1,3-cyclobutanediol monomers were synthesized by copolycondensation in two steps. The synthesis procedure for cis and trans rich polymers was adjusted individually to compensate for variations in the character of the two isomers. The process of polycondensation for the mixture with trans rich monomer occurred faster than that of the 43/57 cis/trans mixture we believe due to lower steric hindrance. The second step of the reaction was carried out in 2 hours for the trans rich material, as opposed to 3 hours for the 43/57 cis/trans monomer mixture. The reaction with the cis rich isomer occurred slower, with a reaction time of 3.5 hours. The polymers were pressed into sheets on a Carver Laboratory Press, model B,

at 160° C. in order to produce test bars.

### Testing and Characterization of Isomerically Pure Copolymers

Dynamic mechanical analysis (DMA) was done on compression molded samples, using a TA Instruments Q800 DMT A. All samples were run at a frequency of 1 Hz with a temperature range of 25-160° C. at 3° C./min in air.

Thermogravimetric analysis (TGA) was carried out on a TA Instruments, Q50 TGA. The temperature ramp rate for TGA was 20° C./min from 25 to 800° C. The sample sizes were in range 10-15 mg, and data were collected under both air and argon atmospheres. Decomposition temperature values were taken from the 10% weight loss point on TGA curves.

Differential Scanning Calorimetry (DSC) was carried out on a TA Instruments Q 200 differential scanning calorimeter in an argon environment. The samples sizes were in range 4-6 mg, the heating rate was 1° C./min. A Bruker D8 powder Xray diffraction unit (with Cu kα) was used for collecting powder X-ray diffraction data of samples. Notched Izod test was performed on a Notched Izod Impact tester with a 2 pound hammer under ASTM D256 conditions.

All synthesized polymers were tested for molecular weight. M_{w} for all samples was about 72-73*10³ g/mol. HPLC for determining molecular weights was performed in chloroform on a Waters 600 controller, a Waters 600 pump with a flow rate 1 ml/min, and a Waters 2487 dual λ abs detector. A sequence of three Waters Styragel HR 4THF 7.8×300 mm columns was used, and the controlling software was Waters Millennim 32.

### RESULTS AND DISCUSSION

Synthesized copolymer samples had different visual appearances. The trans-based copolymer looked opaque, but the cis-based copolymer had high optical clarity. It is well established for crystalline structures, in this case the trans-rich copolymer, that incoming light is highly scattered by the crystalline domains. As a result, the trans-based copolymer appeared semi opaque. In the mixed (43% cis/57% trans) based copolymer, some haziness has been noticed but no crystalline peaks appear in the x-ray diffraction pattern.

Differential scanning calorimetry (DSC) analysis showed that all three copolymers have significant amorphous parts. This is shown by the fact that there were no crystallization and melting temperatures. The highest Tg corresponds to cis-based copolymer. The Tg of the trans-based copolymer is the lowest. The (43% cis/57% trans) mixture has a Tg between cis-based and trans-based copolymers. This behavior confirms that the macromolecules containing higher levels of cis- are more rigid. The parts are less movable, and they need more energy for the transition to glassy state.

The structure of the samples was studied by X-ray diffraction (XRD) analysis before and after annealing. To anneal the samples, they were heated up to their glass transition temperatures and cooled down slowly, during 24 hours. The structures of mixed (43% cis/57% trans) copolymers and cis-based copolymers were amorphous before and after annealing. The trans-based copolymer XRD curve has two sharp peaks at 5.735 A and 5.284 A. These peaks became more pronounced after annealing, demonstrating increasing crystalline phase in the trans-based copolymer.

Thermogravimetric analysis was used for determining decomposition temperatures to define degradation temperatures in copolymer samples. The first derivatives of the weight loss of cis, trans and mixed copolymer show that the cis-based polymer has higher thermostability. The mixed polymer exhibits what appears to be the superposition of two peaks. The lower temperature peak is very close to that of pure trans and the higher one approaches the cis form. The additional thermal stability in the cis may arise from the fact that the cyclobutane ring is somewhat puckered which relieves some of the ring strain. This would indicate that the polymer is somewhat blocky with regions predominated by cis- and trans-. This would be consistent with the kinetics of polymerization discussed earlier.

Differential Mechanical Analysis was performed on the copolymers. Storage modulus for trans-based copolymer is lower relative to mixed (43% cis/57% trans) copolymer. For cis-based copolymer storage modulus in the temperature range 25-75° C. is almost the same, although it retains it's modulus up to 95° C. This is, again, confirmation of the increase in Tg due to the cis monomer and should also be reflected in the heat deflection temperature.

Izod impact strength test showed that the mixed (43% cis/57% trans) copolymer was 944 J/m, and the break shape had crystalline and amorphous areas. For trans-based copolymer Izod impact strength was 841.47 J/m, the break was crystalline. Cis-based copolymer has an Izod impact strength of 1095.3 J/m, the break was amorphous. This increased impact strength as cis-monomer content increases may be due to the molecular geometry around the cyclobutane ring. The kink formed in the polymer chain at the cis-monomer cite may act as a torsion spring that absorbs the energy of impact more efficiently than trans-monomers.

Copolymers with cis/trans ratios of both 46/54 and 18/82 have memory shape and self-healing properties. The copolymer with a cis/trans TACB ratio of 18/82 recovered by 30% after bending and scratching. The experiment was repeated for cis-based and trans-based copolymers. It was found that trans-based copolymer showed the same 30% recovery after bending and scratching. Cis-based copolymer had a fast recovery of 100%. This behavior confirms the difference in molecular morphology of polymers synthesized based on cis- or trans-rich TACB monomers. The cis-monomers, in this case, act as a torsion spring that, when bent, wants to return to its former shape when heated above the Tg. Trans-based copolymers are practically not soluble. This would indicate that the polymer/polymer interactions are much stronger than the solvent/polymer interactions. Cis based copolymer does not form well oriented structures and therefore have fewer polymer/polymer interactions and therefore will dissolve more readily in some solvents.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A polymer which is formed by reaction of a monomer composition, wherein the monomer composition comprises:
a 2,2,4,4-tetraalkyl-1,3-cyclobutanediol monomer in an amount ranging from about 15 mole % to about 25 mole %;
one or more aromatic dicarboxylic acids, aromatic dicarboxylic diesters, and/or aromatic dicarboxylic anhydride in an amount ranging from about 40 mole % to about 60 mole %;
1,3-propanediol or 1,4-butanediol in an amount ranging from about 10 mole % to about 20 mole %;
2,2-dimethyl-1,3-propanediol in an amount ranging from about 10 mole % to about 20 mole %; and
a catalyst that promotes condensation of an alcohol with a carboxylic acid and/or a carboxylic acid ester and/or a carboxylic acid anhydride.

2. The polymer of claim 0, wherein each alkyl group of the 2,2,4,4-tetraalkyl-1,3-cyclobutanediol monomer is independently a C₁-C₈ branched or unbranched alkyl group.

3. The polymer of claim 0, wherein the 2,2,4,4-tetraalkyl-1,3-cyclobutanediol monomer is 2,2,4,4-tetramethyl-1,3-cyclobutanediol.

4. The polymer of claim 1, wherein the monomer composition comprises an aromatic dicarboxylic diester.

5. The polymer of claim 1, wherein the monomer composition comprises dimethyl terephthalate.

6. The polymer of claim 1, wherein the monomer composition further comprises a tin catalyst.

7. The polymer of claim 1, wherein at least 90% of the 2,2,4,4-tetraalkyl-1,3-cyclobutanediol monomer is in the cis form.

8-13. (canceled)

14. The polymer of claim 1, wherein at least 90% of the 2,2,4,4-tetraalkyl-1,3-cyclobutanediol monomer is in the trans form.

15-20. (canceled)

21. A method of forming a polymer comprising:
forming a monomer composition comprising: a 2,2,4,4-tetraalkyl-1,3-cyclobutanediol monomer; one or more aromatic dicarboxylic acids, aromatic dicarboxylic diesters, and/or aromatic dicarboxylic anhydride; 1,3-propanediol or 1,4-butanediol; and a catalyst that promotes condensation of an alcohol with a carboxylic acid and/or a carboxylic acid ester and/or a carboxylic acid anhydride;
heating the monomer composition to a temperature greater than about 200° C. at a pressure of less than 760 mm Hg but greater than 1 mm Hg;
cooling the heated monomer composition;
heating the cooled monomer composition to a temperature greater than about 200° C. at a pressure of less than 1 mm Hg to form the polymer.

22. The method of claim 21, further comprising adding additional catalyst to the cooled monomer composition prior to heating the cooled monomer composition.

23. The method of claim 21, wherein at least 90% of the 2,2,4,4-tetraalkyl-1,3-cyclobutanediol monomer is in the cis form.

24. The method of claim 21, wherein at least 90% of the 2,2,4,4-tetraalkyl-1,3-cyclobutanediol monomer is in the trans form.

25. The method of claim 21, wherein the monomer composition further comprises 2,2-dimethyl-1,3-propanediol.
